(19) United States
(12) Patent Application Publication
(10) Pub. No.: US 2007/0168334 A1
(43) Pub. Date: Jul. 19, 2007

(54) Normalization support in a database design tool

(76) Inventors: Loic R. Julien, Seattle, WA (US); Wei Liu, Newcastle, WA (US); Hong-Lee Yu, Woodinville, WA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/332,081

(22) Filed: Jan. 13, 2006

(51) Int. Cl. G06F 17/30

(52) U.S. Cl. 707/3

(57) ABSTRACT

Provided are techniques for identifying normalization violations. Selection of one of a data model, a portion of the data model, and an object in the data model is received. Selection of one or more normalization rules is received. One or more normalization violations are identified in the one of the data model, the portion of the data model, and the object in the data model using the one or more normalization rules. The one or more normalization violations are displayed.

### BACKGROUND

1. Field

Embodiments of the invention relate to normalization support in a database design tool.

2. Description of the Related Art

Relational DataBase Management System (RDBMS) software may use a Structured Query Language (SQL) interface. The SQL interface has evolved into a standard language for RDBMS software and has been adopted as such by both the American National Standards Institute (ANSI) and the International Standards Organization (ISO).

A RDBMS uses relational techniques for storing and retrieving data in a database. Databases are computerized information storage and retrieval systems. Databases are organized into tables that consist of rows and columns of data. The rows may be called tuples or records or rows. A database typically has many tables, and each table typically has multiple records and multiple columns. The term “field” is sometimes used to refer to a column of a table.

A table in a database can be accessed using an index. An index is an ordered set of references (e.g., pointers) to the records in the table. The index is used to access each record in the table using a key (i.e., one of the columns of the record). Without an index, finding a record requires a scan (e.g., linearly) of an entire table. Indexes provide an alternate technique to accessing data in a table. Users can create indexes on a table after the table is built. An index is based on one or more columns of the table.

A query may be described as a request for information from a database based on specific conditions. A query typically includes one or more predicates. A predicate may be described as an element of a search condition that expresses or implies a comparison operation (e.g., A=3).

A design topic in database design is the process of normalizing tables in the database.

Unnormalized tables present certain problems, called anomalies, when attempts are made to update data in them. An insert anomaly refers to a situation when a new row cannot be inserted into a table because of an artificial dependency on another table. The error that caused the anomaly is that columns of two different tables are mixed into the same relation. The delete anomaly occurs when a deletion of data about one particular table causes unintended loss of data that characterizes another table. The update anomaly occurs when an update of a single data value requires multiple rows of data to be updated.

Normalization is used to remove the anomalies from the data. The normalization process produces a set of tables in a data model that has a certain set of properties. Dr. E. F. Codd, instrumental in developing the database, developed the process using three normal forms. A table, which is data represented logically in a two-dimensional format using rows and columns, is assigned a primary key for an entity that the table represents. The primary key is formed by one or more columns that uniquely identify the table. Non-key columns are columns that are not part of the primary key. Then, through a series of steps that apply normalization rules, the table is reorganized into different normal forms. The normalization rules remove normalization violations from the table. To place the table in the first normal form, a normalization rule removes the normalization violations of repeating and multivalued columns from the table (e.g., an example of repeating columns is a table with two columns named Address1 and Address2 and an example of a multivalued column is a Name column that includes a first name and a last name). To place the table in second normal form, the normalization rule of “removing partially dependent columns” is applied to the table. For a table that has multiple columns that form a primary key, a non-key column that depends on fewer than all of the columns forming the primary key is a partially dependent column. The table is in third normal form after transitively dependent columns are removed from the table. For a table that has a primary key, a non-key column that depends on another non-key column is a transitively dependent column. Normalizing the tables avoids redundancy, permits efficient updates of data in the database, maintains data integrity, and avoids the danger of unknowingly losing data. Descriptions of the first normal form, the second normal form, and the third normal form may use the term “field”, however, when these forms are applied to a database table, the term “field” refers to a column.

However, making the database completely normalized often comes with heavy performance penalties for database queries. Database designers often purposely denormalize certain tables to improve overall performance of the database management system. The denormalizations that are intentionally made during the design of the database should be communicated to application developers, so that they can add additional logic in the application to prevent anomalies and insure data integrity.

Conventional data modeling tools fail to identify denormalizations to application developers. Therefore, there is a need for a modeling tool that allows database designers to explicitly design denormalized tables into the database and to annotate these denormalized tables so that developers can identify them. There is also a need for a modeling tool that automatically discovers and infers violations of the normal forms during the design process, so that designers can remove unintended denormalizations. Conventional modeling tools, which fail to meet these needs, are prone to serious coding errors that do not maintain integrity of data relied on by business.

### SUMMARY OF EMBODIMENTS OF THE INVENTION

Provided are a method, computer program product, and system for identifying normalization violations. Selection of one of a data model, a portion of the data model, and an object in the data model is received. Selection of one or more normalization rules is received. One or more normalization violations are identified in the one of the data model, the portion of the data model, and the object in the data model using the one or more normalization rules. The one or more normalization violations are displayed.

### BRIEF DESCRIPTION OF THE DRAWINGS

Referring now to the drawings in which like reference numbers represent corresponding parts throughout:

FIG. 1 illustrates details of a computing environment in accordance with certain embodiments.

FIG. 2 illustrates logic performed by a modeling tool in accordance with certain embodiments.

FIG. 3 illustrates a data model in accordance with certain embodiments.

FIG. 4 illustrates logic performed by a design analysis tool in accordance with certain embodiments.

FIG. 5A illustrates a context menu that enables selection of design analysis by a design analysis tool in accordance with certain embodiments.

FIG. 5B illustrates an analyze model dialog screen displayed by a design analysis tool in accordance with certain embodiments.

FIG. 6 illustrates an example of a first normal form violation with a repeating group that can be discovered by a design analysis tool in accordance with certain embodiments.

FIG. 7 illustrates an example of a second normal form violation of a data model that can be discovered by a design analysis tool in accordance with certain embodiments.

FIG. 8 illustrates an example of a third normal form violation of a data model that can be discovered by a design analysis tool in accordance with certain embodiments.

FIG. 9A illustrates a display of normal form violations for a portion of a data model in accordance with certain embodiments.

FIG. 9B illustrates a display once normal form violations have been corrected in accordance with certain embodiments.

FIG. 10 illustrates an example of dependency relationships that are added by a user in accordance with certain embodiments.

FIG. 11 illustrates logic performed by a dependency and impact analysis tool in accordance with certain embodiments.

FIG. 12 illustrates a context menu that enables selection of a dependency and impact analysis tool in accordance with certain embodiments.

FIG. 13 illustrates an architecture of a computer system that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

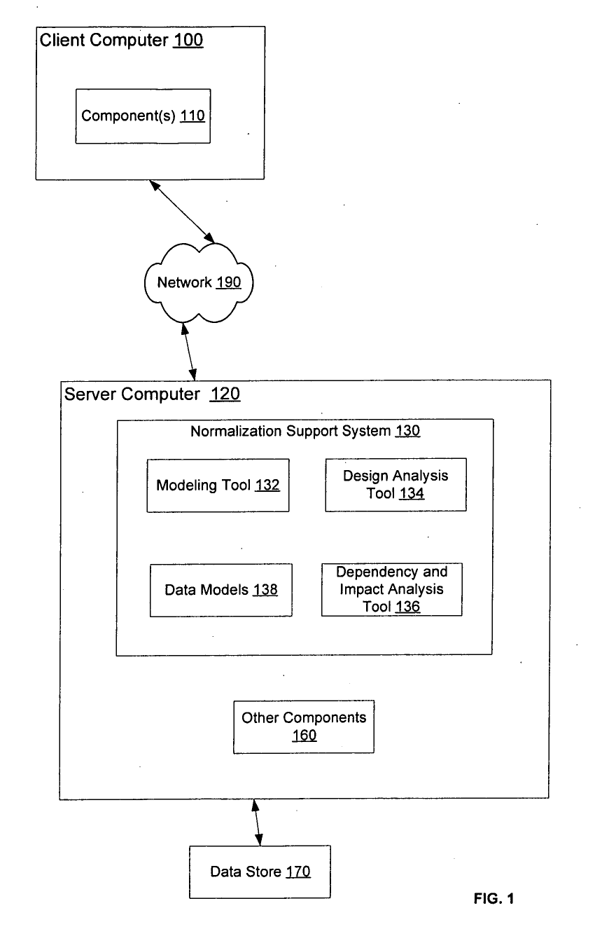

FIG. 1 illustrates details of a computing environment in accordance with certain embodiments. A client computer 100 is connected via a network 190 to a server computer 120. The client computer 100 includes one or more components 110, such as client applications. The client computer 100 may issue queries to the server computer 120.

The server computer 120 includes a normalization support system 130 and may include other components 160, such as server applications. The normalization support system 130 includes a modeling tool 132, a design analysis tool 134, a dependency and impact analysis tool 136, and one or more data models 138. A data model 138 describes a database structure (e.g., identifies tables and columns to be created for a database). Elements of a database described in a data model 138 (e.g., tables, columns, etc.) may be described as objects in the data model 138.

The data modeling tool 132 enables a user (e.g., a database designer) to create a new data model 138 or edit an existing data model 138. Additionally, the data modeling tool 132 enables a user to annotate denormalizations in a data model 138 using functional dependencies and naming patterns. Also, the design analysis tool 134 discovers and infers violations of normalization rules in a data model 138 using a rule based analysis of the data model 138. The design analysis tool 134 displays any discovered violations with visual cues that identify the denormalized tables in the data model 138. The dependency and impact analysis tool discovers dependencies between objects in the data model 138 (e.g., between columns described in the data model 138) that indicate that dependent objects may be impacted by changes to the object on which they are dependent. A functional dependency, denoted by X→Y, between two sets of attributes X and Y that are subsets of the attributes of a relation R, specifies that the values in a tuple corresponding to the attributes in Y are uniquely determined by the values corresponding to the attributes in X. For example, a social security number (SSN) uniquely determines a name, so an example of a functional dependency is: SSN→Name. Functional dependencies may be determined by the semantics of the relation, but, in general, they are not determined by inspection of an instance of the relation. That is, a functional dependency is a constraint and not a property derived from a relation.

The server computer 120 is coupled to a data store 170. The data store 170 may store one or more databases that are created based on the one or more data models 138.

The client computer 100 and server computer 120 may comprise any computing device known in the art, such as a server, mainframe, workstation, personal computer, hand held computer, laptop telephony device, network appliance, etc.

The network 190 may comprise any type of network, such as, for example, a peer-to-peer network, spoke and hub network, Storage Area Network (SAN), a Local Area Network (LAN), Wide Area Network (WAN), the Internet, an Intranet, etc.

The data store 170 may comprise an array of storage devices, such as Direct Access Storage Devices (DASDs), Just a Bunch of Disks (JBOD), Redundant Array of Independent Disks (RAID), virtualization device, etc.

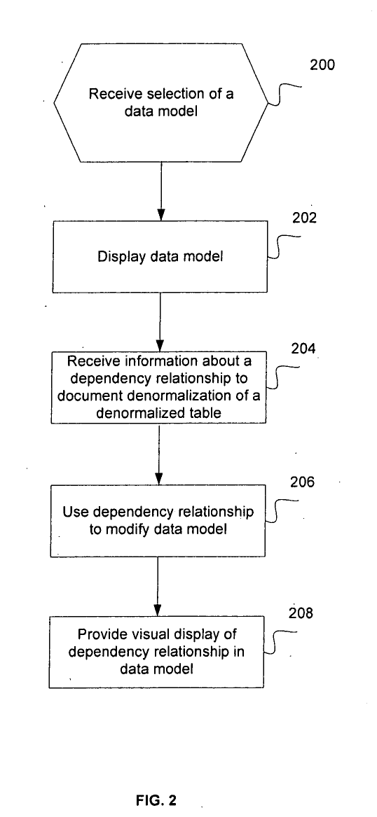

FIG. 2 illustrates logic performed by the modeling tool 132 in accordance with certain embodiments. Control begins at block 200 with the modeling tool 132 receiving selection of a data model 138. In block 202, the modeling tool 132 displays the data model 138. In block 204, the modeling tool 132 receives information about a dependency relationship to document denormalization of a denormalized table. That is, a user may intentionally denormalize a table in the data model 138 (e.g., by adding a functional dependency between columns of a table in the data model 138). Using the data modeling tool 132, the user may add a dependency relationship to the denormalized table to document the denormalization. In block 206, the modeling tool 132 uses the dependency relationship to modify the data model (i.e., to model a dependency (e.g., a functional dependency) in the data model 138). In block 208, the modeling tool provides a visual display of the dependency relationship in the data model 138.

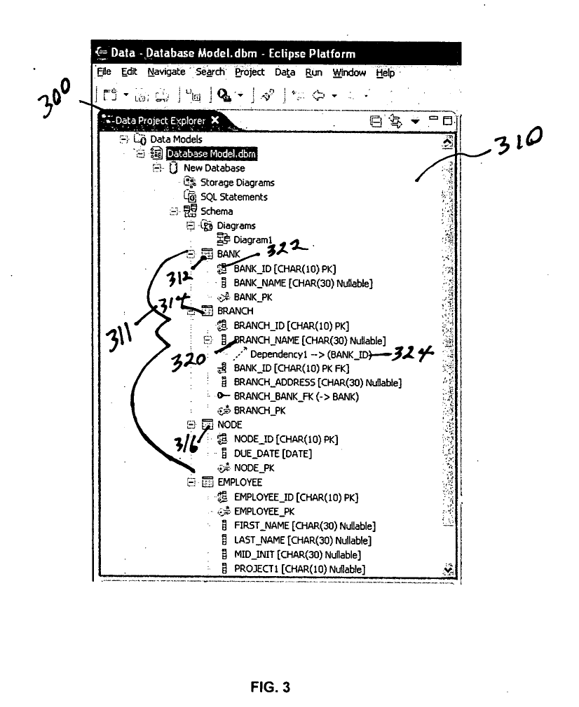

FIG. 3 illustrates a data model 310 in accordance with certain embodiments. In FIG. 3, the data model 310 has been created using the modeling tool 132. The data model 310 is displayed under a Data Project Explorer tab 300. A portion 311 of the data model 310 describes a Bank table 312, a Branch table 314, and a Node table 316. For the Bank_Name column 320 in the Branch table 314, the modeling tool 132 has received information about a dependency relationship with the Bank_ID column 322 and provides a visual display of the dependency relationship 324.

A database management system (e.g., an RDBMS) may use the data model 310 to create a physical database having the database objects (e.g., tables and columns) described in the data model 310.

Additionally, the user may select the data model 310 to be analyzed by the design analysis tool 134 in order to determine normalization violations. Moreover, the user may select the data model 310 to be analyzed by the dependency and impact analysis tool 136 to identify dependencies (including functional dependencies).

In certain cases, the user may want to intentionally denormalize portions of the data model 138. Normalization leads to more relations, which results in more joins. This often causes a performance bottleneck when many concurrent users access the data model 138. When database users suffer performance problems that cannot be resolved by other means, such as tuning the database, then denormalization may be performed. The user can improve the overall performance of a database management system by denormalizing the data model 138. The modeling tool 132 can be used by the user to annotate the denormalizations in the data model 138 so that users can create applications that interact with the data model 138 while avoiding denormalization problems, such as insert and delete anomalies.

For example, a user creates a data model 138 for a bookstore to record the books that are sold. If the data model 138 is normalized, to retrieve the last name of an author of a book, a join is performed on a titleauthor table, which has a title id column and an author id column, and an authors table, which has an author id column and an author's last name column. To eliminate the join, the user can add the author's last name column to the titleauthor table. The titleauthor table is now denormalized because it has a redundant column. In certain embodiments, the user can use the modeling tool 132 to annotate such a denormalization in the data model 138.

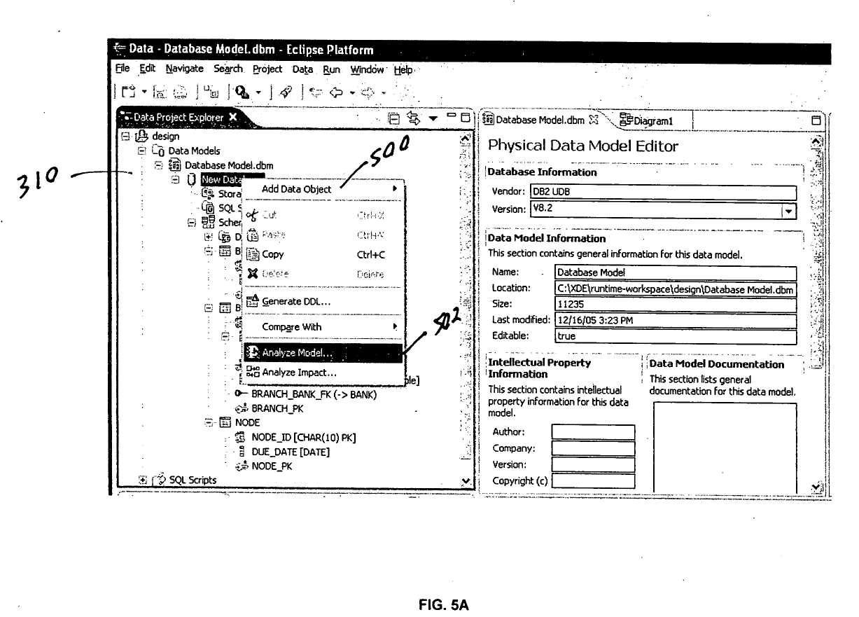

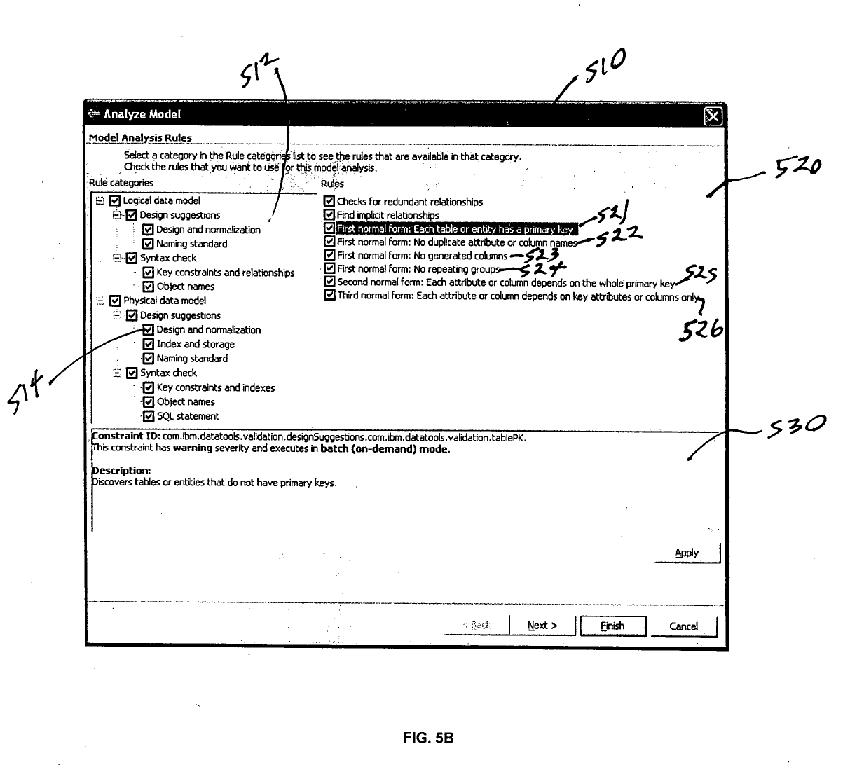

The user may also add a derived column to a table to eliminate joins and reduce the amount of time to produce aggregate values. For example, a summary column, such as a total sales column, can be added to a table of authors. The data in the total sales column for a particular author is determined by aggregating the total sales for each title that was written by the author. The user can create and maintain this derived column in the authors table, so that the database can return the total sales for a particular author without aggregating the title tables and joining the aggregation with the authors table at run time. In certain embodiments, the user can use the modeling tool 132 to annotate the derived column in the data model 138. A derived column rule, such as the no generated columns rule 523 in FIG. 5 (described below), can be selected by users (e.g., application developers) so that the design analysis tool 134 identifies the derived column in the denormalized table.

If most users need to see a full set of joined data from two tables, collapsing the two tables into one table can improve performance by eliminating the join. The collapse can be performed when the data in the two tables have a one to one relationship. For example, a normalized data model 138 may have an authors table with an author id column and an author's last name column, and a book table may have an author id column and a book copy column. If users frequently need to see the author's name, the author id, and the book copy data at the same time, then the two tables can be combined into a new authors table that has an author id column, an author's last name column, and a book copy column. In certain embodiments, the user can use the modeling tool 132 to document the collapse.

If a group of users regularly needs only a subset of data, the user can duplicate the subset of data into a new table. In certain embodiments, the user can use the modeling tool 132 to annotate the duplication in the data model 138. A global uniqueness rule, such as the duplicate columns rule 522 shown in FIG. 5 (described below), can be selected by users so that the design analysis tool 134 identifies duplicate data (i.e., identifies a redundant column in a denormalized table). A global uniqueness rule may be described as a rule that is used to enforce unique names in a database. The rule is global in that the rule is applicable to a database. For example, an employee table has a name column and a bank table has a name column. If the name columns have the same names (e.g., both are called “Name”), the name columns are not globally unique. On the other hand, if the name columns have different names (e.g., “Emp_Name” and “Bank_Name”), the name columns have unique names.

A user can split one table into multiple smaller tables to improve performance. Horizontal splitting may be described as splitting one table with a large number of columns into multiple tables, each having a smaller number of columns. If a table is split horizontally, then a global uniqueness rule such as the duplicate columns rule 522 in FIG. 5 (described below) can be used by the design analysis tool 134 to identify the duplicate columns to other users. The user can use horizontal splitting to reduce the size of a large table, and reducing the size of the table reduces the number of index pages read in a query. Horizontal splitting may also be used when the table split corresponds to a natural separation of rows, such as different geographical sites, or historical and current data. The horizontal split can remove the rarely used historical data to satisfy the performance needs for the current data in the table. For example, a table that contains data for inactive authors and active authors can be split into an active authors table and an inactive authors table. The two tables will have the same column names, which can be detected by a global uniqueness rule (e.g., rule 522 in FIG. 5) that is applied to the data model 138 by the design analysis tool 134. In certain embodiments, the user can use the modeling tool 132 to annotate the horizontal split in the data model 138.

A user can split a table vertically if some columns are accessed more frequently than other columns, or if the table has wide rows, and splitting the table reduces the number of pages that need to be read. Vertical splitting may be described as taking a single table with a large number of rows and cutting the table into two tables, so that that each of these tables is easier to search (e.g., a table that has 100,000 rows may be split vertically into two tables, each having 50,000 rows). In certain embodiments, the user can use the modeling tool 132 to annotate the vertical split in the data model 138.

If a schema has supertypes and subtypes, the subtype can be rolled back into its supertype to improve application performance. Supertype may be described as a type of a table from which another table may be derived (e.g., for a supertype employee table, a full_time_employee table may be derived that includes a subset of the columns of the supertype employee table). Subtypes are created when a supertype, such as an Employee table, is subdivided into several tables because some data lack common columns. For example, some employees may lack a forklift operator's license number. Therefore, to normalize the Employee table, a subtype table is created for employees that have an operator's license. The supertype employee table may be denormalized by rolling the subtype table back into the supertype employee table, which may increase application performance.

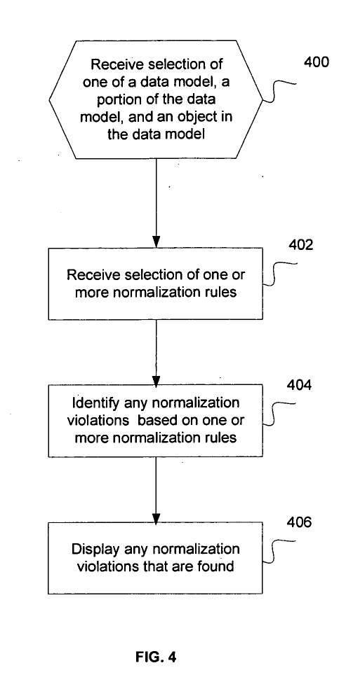

FIG. 4 illustrates logic performed by the design analysis tool 134 in accordance with certain embodiments. Control begins at block 400 with the design analysis tool receiving selection of one of a data model 138 (e.g., data model 310), a portion of the data model 138 (e.g., portion 311 of the data model 310), and an object in the data model 138 (e.g., a table in the data model 310). The data model 310 may be a logical (“conceptual”) data model or a physical data model. A logical data model may be described as a version of a data model that represents the business requirements of an organization and is developed before a physical data model. A physical data model may be described as being associated with a database, which, in turn, contains one or more schemas. A schema may be described as consisting of information about the structure and content of the database, how data in the database is stored internally, and how the data is stored physically on a storage device.

In block 402, the design analysis tool 134 receives selection of one or more normalization rules. That is, the user selects normalization rules to apply to the selected data model 138, portion of the data model 138, or object in the data model 138. The normalization rules are used to determine whether the data model 138, portion of the data model 138 or object in the data model 138 violates the first normal form, the second normal form, and the third normal form. In block 404, the design analysis tool 134 identifies any normalization violations in the selected data model 138, portion of the data model 138, or object in the data model 138 based on the one or more normalization rules. In block 406, the design analysis tool 134 displays any normalization violations that are found.

Thus, the design analysis tool 134 discovers and infers instances of normalization violations. If any normalization violations are found, they are displayed to a user. Then, the user may correct a normalization violation (e.g., by removing a dependency such as dependency 334 from the data model 310).

FIG. 5A illustrates a context menu 500 that enables selection of design analysis by the design analysis tool 134 in accordance with certain embodiments. In certain embodiments, a user may use a mouse to point at the data model 310 and click a right mouse button to obtain a context menu 500 from which an Analyze Model option 502 may be selected to invoke the design analysis tool 134. FIG. 5B illustrates an analyze model dialog screen 510 displayed by the design analysis tool 134 in accordance with certain embodiments. Within the analyze model dialog screen 510, the user can select one or more normalization rules to apply to the data model 310. In FIG. 5B, a list of rule categories is displayed by the dialog in area 512. The user may select, for example, one of the rule categories in the list, such as the design and normalization category 514 for data model 310. The design and normalization rules from the selected category 514 are then displayed in area 520. The user can select each rule to be used during the analysis of the data model 138. An explanation of a particular rule can be displayed in area 530 by selecting the rule (e.g., by highlighting the rule). After the user selects the desired rules, the design analysis tool 134 applies the rules to the data model 138. Rules 521, 522, 523, and 524 are used to determine whether any table in the data model 138 violates the first normal form. A table is in first normal form if the table contains a primary key, if there are no duplicate column names, if there are no generated columns, and if there are no multivalued or repeating columns (i.e., if each column in the table is atomic). A column is atomic when it contains the smallest data element possible.

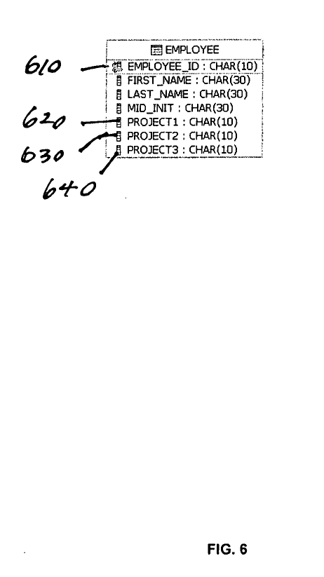

Primary key rule 521 determines whether each table in the data model 138 has a primary key. The primary key is a collection of one or more columns that uniquely identifies each table. The primary key value may include data in a single column or may be composed of data in several columns. FIG. 6 illustrates an example of a first normal form violation with a repeating group that can be discovered by the design analysis tool 134 in accordance with certain embodiments. In this example, the primary key 610 is the employee id column, which uniquely identifies the employee table. In this example, the design analysis tool 134 determines that rule 521 has not been violated.

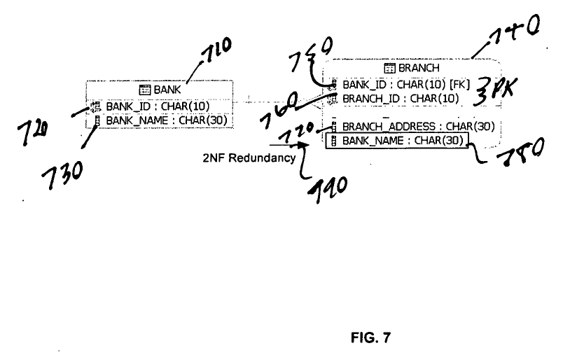

Another property of a table in the first normal form is that it contains no duplicate attribute or column names. A duplicate columns rule 522 is used to examine the names of columns to determine whether any columns have the same name, or begin with the same prefix and differ only by the ending numbers. An example of duplicate column names is shown in FIG. 7 with the Bank_Name columns 730, 780 in the Bank table 710 and the Branch table 740. In this example, the Bank_Name columns 730, 780 are identified by the design analysis tool 134 as duplicate column names that violate the first normal form.

The generated columns rule 523 is used to determine whether a column contains data that is generated using data from other columns (e.g., a summary column, such as a total sales column that summarizes values from other columns).

The repeating groups rule 324 examines the tables in the data model to determine whether any tables have repeating groups. An example of a repeating group is shown in FIG. 6. The project column is repeated three times, to contain data for three different projects in one table, including “project1” 620, “project2” 630, and “project3” 640. In this example, the three project columns are identified by the design analysis tool 134 as repeating columns that violate the first normal form.

Returning to FIG. 5, the second normal form rule 525 is used to determine whether each column depends on the whole primary key. A table is in second normal form if it is normalized to first normal form and if each column refers to or describes the primary key value. If the primary key is based on more than one column (i.e., forms a “complex” key), each non-key column must depend on the complex key (i.e., on all columns of the primary key), not just one column within the complex key. In other words, all non-key columns should be functionally dependent on the entire primary key.

The second normal form rule 525 identifies columns that are functionally dependent on columns that are not the complete primary key. FIG. 7 illustrates an example of a second normal form violation of the data model 310 of FIG. 3 that can be discovered by the design analysis tool 134 in accordance with certain embodiments. The fact that the bank id in the Bank_ID column 720 uniquely identifies the bank name in the Bank_Name column 730 in the Bank table 710 means that the bank name is functionally dependent on the bank id. That is, in the Bank table 710, the Bank_Name column 730 is functionally dependent on the Bank_ID column 720 because at any given point in time there can only be one bank name associated with a given bank id. The Bank_ID column 720 is the primary key (PK) of the Bank table 710. Because the Bank_Name column 730 is functionally dependent on the Bank_ID column 720, which is the primary key, the Bank table 710 satisfies the second normal form.

Also in FIG. 7, the primary key for the Branch table 740 is a composite of the Bank_ID column 750 and the Branch_ID column 760. That is, two columns 750, 760 are used to form the primary key for the Branch table 740. The non-key columns in the Branch table 740 are the Branch_Address column 770 and the Bank_Name column 780. A table is in second normal form if each non-key column of the table is functionally dependent on the entire primary key (i.e., all columns forming the primary key) for the table. In the example of FIG. 7, the branch address in the Branch_Address column 770 are uniquely identified by the bank id in the Bank_ID column 750 and the branch id in the Branch_ID column 760, which together form the primary key for the Branch table 740. The Branch_Address column 770 is functionally dependent on the entire primary key of the Branch table 740, and satisfy the second normal form. However, the bank name in the Bank_Name column 780 is uniquely identified by the bank id in the Bank_ID column 750. Thus, the Bank_Name column 780 is functionally dependent on the Bank_ID column 750, which is only a portion of the primary key. Therefore, the design analysis tool 134 determines that the Branch table 740 violates the second normal form, as represented by the second normal form (2NF) redundancy arrow 790.

Thus, the design analysis tool 134 examines the functional dependencies of the tables in the data model 138 with the second normal form analysis rule to identify potential violations. The functional dependencies, such as that between the bank name and the bank id, can be added during the design of the data model 138 with the data modeling tool 132. The design analysis tool 134 compares the functional dependency of each column in a table with the primary key of the table to infer violations. For example, the rule uses the dependency of the Bank_Name column 780 to infer that the bank name in the Branch table 740 is functionally dependent on only a portion of the primary key for the branch table and violates the second normal form.

The third normal form rule 526 shown in FIG. 5 is used to determine whether each column in the data model 138 depends only on the primary key. A table is in third normal form if it is in second normal form and all columns are mutually independent. The third normal form is achieved by removing transitive dependencies, which occur when non-key columns are dependent on other non-key columns. Thus, when the third normal form is satisfied, all non-key columns depend only on the primary key.

The dependencies of the columns in each table of the data model 138 can be added by the user when the data model 138 is created with the data modeling tool 132. The third normal form rule can then be used to implement a dependency analysis to discover the functional dependencies. For example, the third normal form rule 526 shown in FIG. 5 compares the dependencies of each column in the tables shown in FIG. 3 with the primary key for each of the tables to identify columns that are transitively dependent on one or more non-key columns. Any identified column violates the third normal form.

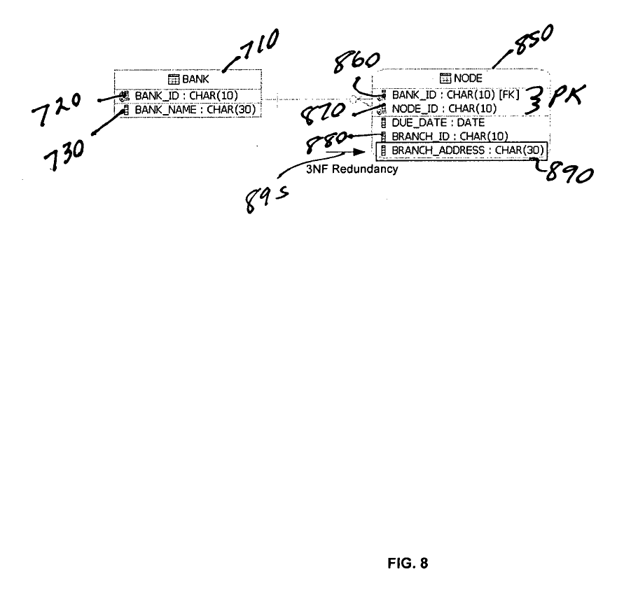

FIG. 8 illustrates an example of a third normal form violation of the data model 310 of FIG. 3 that can be discovered by the design analysis tool 134 in accordance with certain embodiments. In FIG. 8, the primary key for the Node table 850 is a composite key formed by the Bank_ID column 860 and the Node_ID column 870. However, the Branch_Address column 890 in the Node table 850 is not functionally dependent on the Node_ID column 870. Rather, the Branch_Address column 890 is dependent on the Bank_ID column 860 and the Branch_ID column 880. This transitive dependence of the Branch_Address column 890 in the Node table 850 on column 880, which is not a key column of the Node table 850, is a violation of the third normal form as indicated by the third normal form (3NF) redundancy arrow 895.

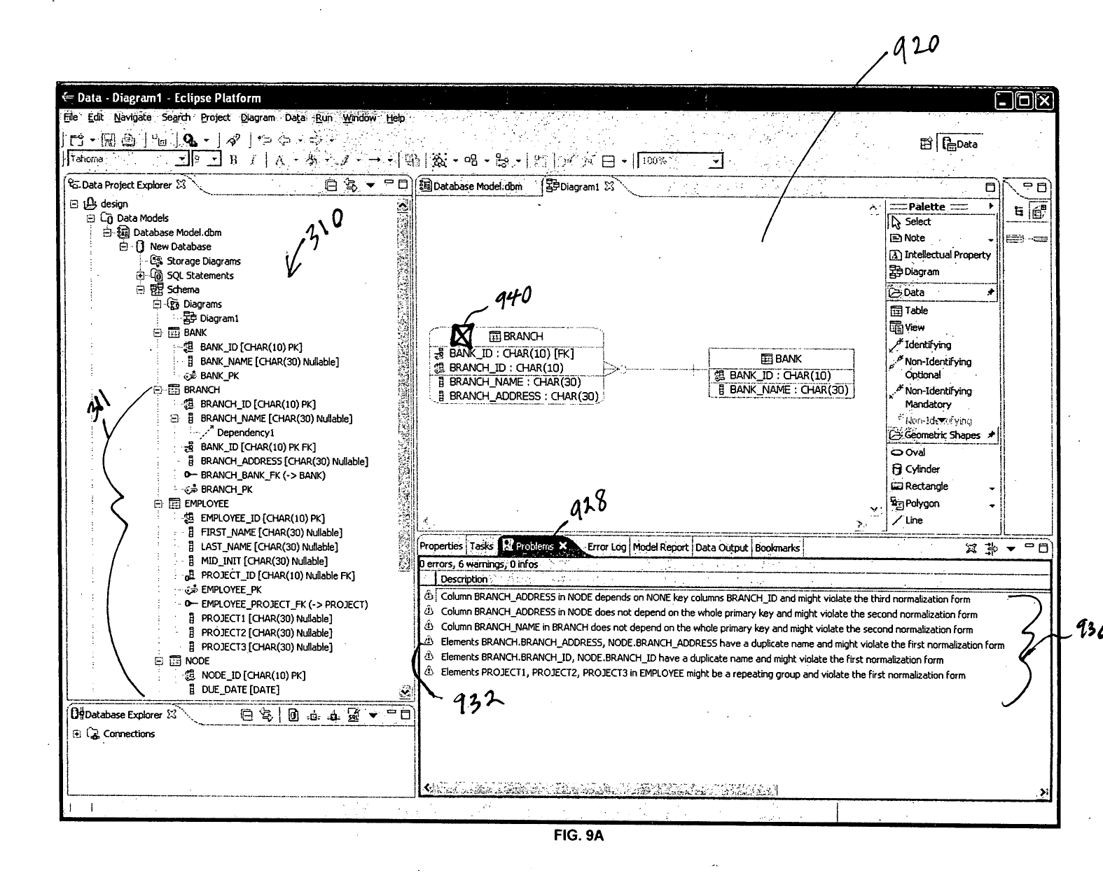

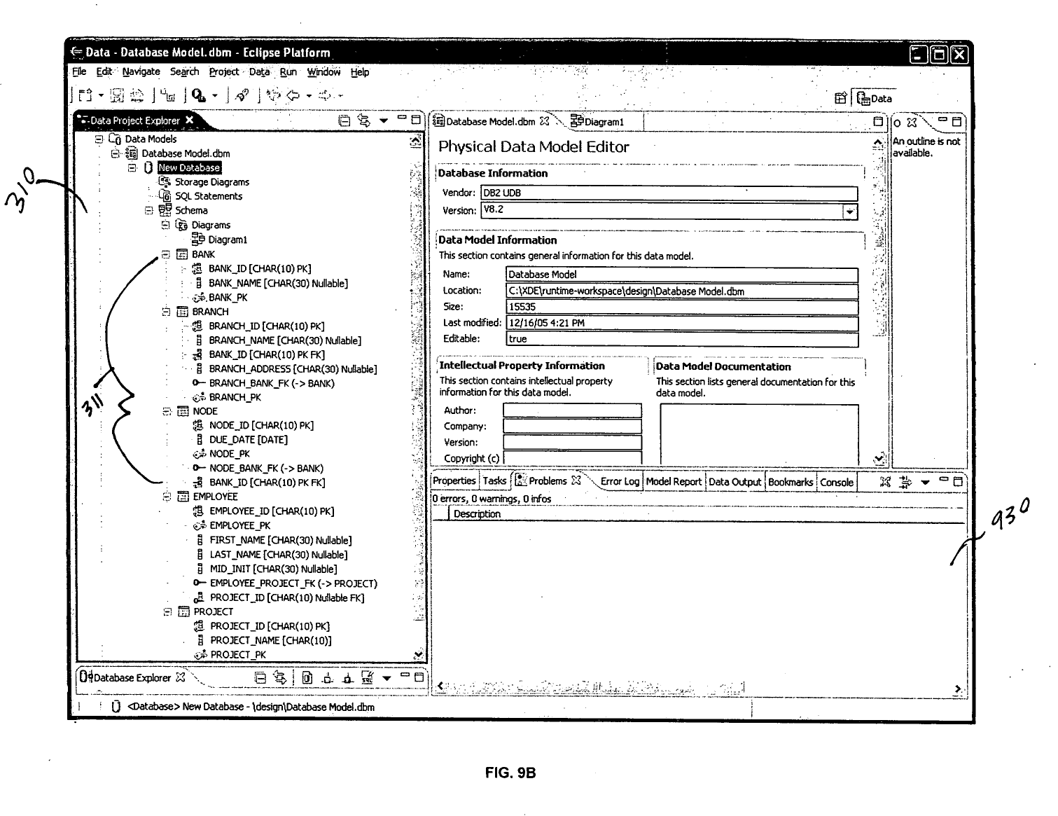

FIG. 9A illustrates a display of normal form violations for a portion 311 of a data model 310 in accordance with certain embodiments. For the portion 311 (FIG. 3) that has been analyzed, the design analysis tool 134 displays the normal form violations 930 under a Problems tab 928. For example, normal form violation 932 indicates that the Branch_Address column 770 of the Branch table 740 has a same name as the Branch_Address column 890 of the Node table 850. Additionally, a visual cue of each normal form violation listed in area 930 can be displayed in area 920. For example, a visual cue 940 of a normal form violation is displayed. The visual cue of an X in a box is provided merely for illustration, and various embodiments may use any visual cue to identify a normal form violation. Also, in certain embodiments, different visual cues may be used for different normal form violations.

The user can examine the tables that are associated with the violations 930, and modify the tables so that the tables are normalized. Thus, after the design analysis tool 134 discovers normalization violations, the user can create a normalized data model 138 by changing the denormalized tables identified by the design analysis tool 134. FIG. 9B illustrates a display once normal form violations have been corrected in accordance with certain embodiments. In FIG. 9B, portion 311 of the data model has been modified by a user using the modeling tool 132 (is this accurate), and there are no normal form violations 930.

With a normalized data model 138, subsequent users of the data model 138 can add data to and remove data from the data model 138 without experiencing data anomalies. The normalized data model 138 provides indexing, minimizes or eliminates anomalies caused by data modification, reduces the size of tables, and enforces referential integrity.

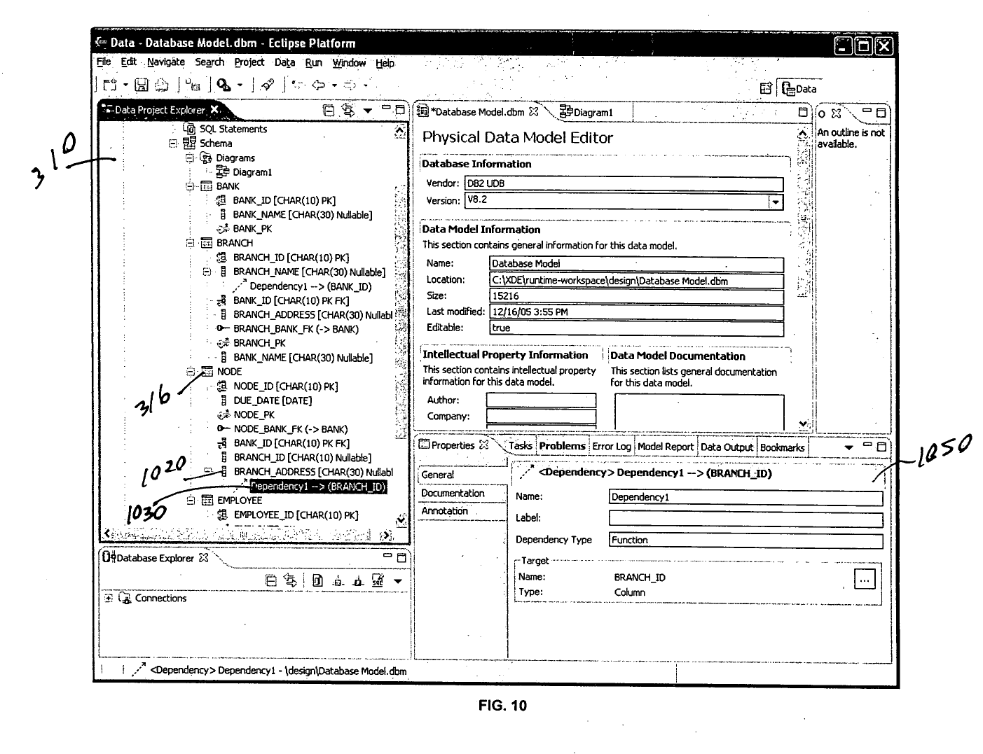

A user may add dependency relationships to the data model 138 to annotate functional dependencies and document the denormalizations using the modeling tool 132. FIG. 10 illustrates an example of dependency relationships that are added by a user in accordance with certain embodiments. The Node table 316 is denormalized because the Branch_Address column 1020 has a dependency 1030 with the Branch_ID column 1040. The user adds the dependency relationship to the data model 310 to annotate the functional dependency of the denormalized table using a Properties view 1050.

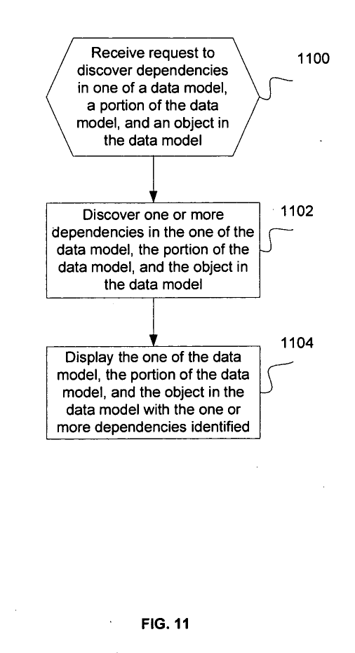

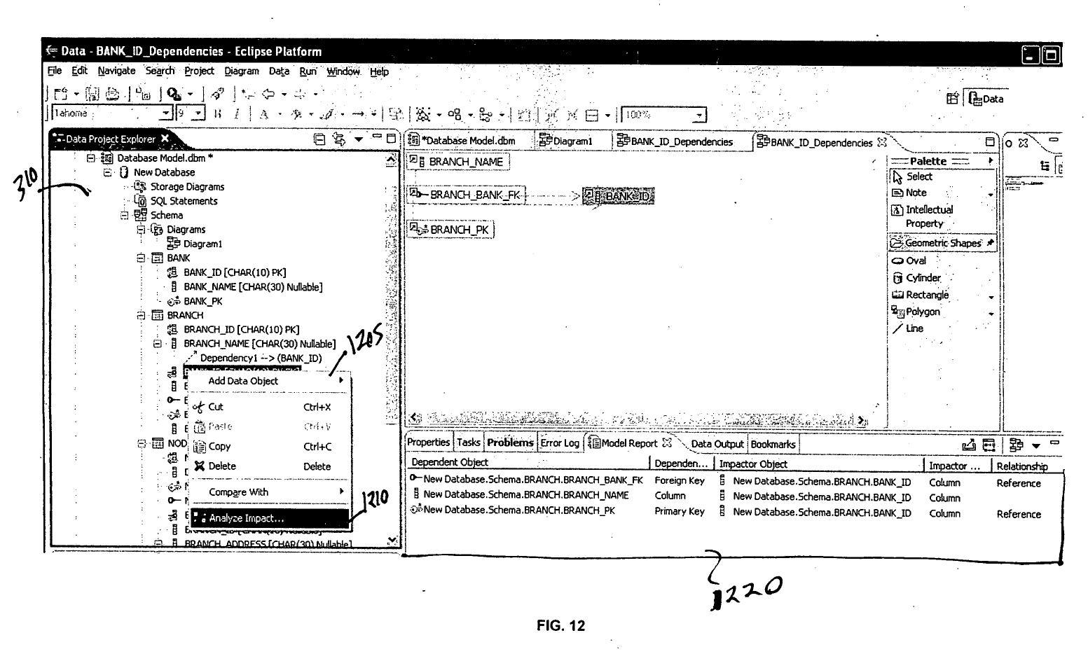

FIG. 11 illustrates logic performed by the dependency and impact analysis tool 136 in accordance with certain embodiments. The dependency and impact analysis tool 136 is applied to a data model 138 to discover dependencies. Control begins at block 1100 with the dependency and impact analysis tool 136 receiving a request to discover dependencies in at least one of a data model 138 (e.g., data model 310), a portion of the data model 138 (e.g., portion 311 of the data model 310), and an object in the data model 138 (e.g., a table in the data model 310). In block 1102, the dependency and impact analysis tool 136 discovers one or more dependencies in one of a data model, a portion of the data model, and an object in the data model by examining tables in the data model and by reviewing the annotations of dependencies provided by the user. Thus, the annotations created using the modeling tool 132 are used by the dependency and impact analysis tool 136. In block 1104, the dependency and impact analysis tool 136 displays the one of the data model 138, the portion of the data model, and the object in the data model with dependencies identified. FIG. 12 illustrates a context menu that enables selection of the dependency and impact analysis tool 136 in accordance with certain embodiments. Also, FIG. 12 shows the results of applying the dependency and impact analysis tool 136 to the data model 310 shown in FIG. 12. The user selects an “Analyze Impact” function 1210 from menu 1205 to invoke the dependency and impact analysis tool 136. The dependency and impact analysis tool 136 identifies functional dependencies and displays these in dependency and impact area 1220. A dependent object is dependent upon an impactor object, and, if changes are made to the impactor object, then, the dependent object may be impacted. For example, a change to the Bank_ID column of the Branch table may impact the Branch_Bank_FK column of the Branch table.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk—read only memory (CD-ROM), compact disk—read/write (CD-R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIGS. 2, 4, and 11 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2, 4, and 11 may be implemented in software, hardware, programmable and non-programmable gate array logic or in some combination of hardware, software, or gate array logic.

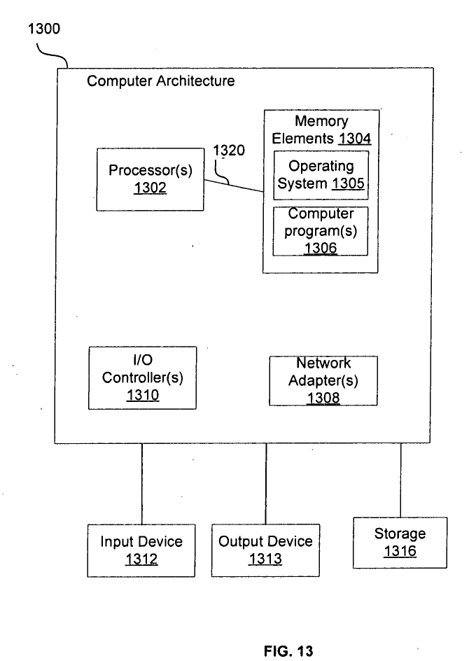

FIG. 13 illustrates a system architecture 1300 that may be used in accordance with certain embodiments. Client computer 100 and/or server computer 120 may implement system architecture 1300. The system architecture 1300 is suitable for storing and/or executing program code and includes at least one processor 1302 coupled directly or indirectly to memory elements 1304 through a system bus 1320. The memory elements 1304 may include local memory employed during actual execution of the program code, bulk storage, and cache memories which provide temporary storage of at least some program code in order to reduce the number of times code must be retrieved from bulk storage during execution. The memory elements 1304 include an operating system 1305 and one or more computer programs 1306.

Input/Output (I/O) devices 1312, 1314 (including but not limited to keyboards, displays, pointing devices, etc.) may be coupled to the system either directly or through intervening I/O controllers 1310.

Network adapters 1308 may also be coupled to the system to enable the data processing system to become coupled to other data processing systems or remote printers or storage devices through intervening private or public networks. Modems, cable modem and Ethernet cards are just a few of the currently available types of network adapters 1308.

The system architecture 1300 may be coupled to storage 1316 (e.g., a non-volatile storage area, such as magnetic disk drives, optical disk drives, a tape drive, etc.). The storage 1316 may comprise an internal storage device or an attached or network accessible storage. Computer programs 1306 in storage 1316 may be loaded into the memory elements 1304 and executed by a processor 1302 in a manner known in the art.

The system architecture 1300 may include fewer components than illustrated, additional components not illustrated herein, or some combination of the components illustrated and additional components. The system architecture 1300 may comprise any computing device known in the art, such as a mainframe, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the embodiments, the embodiments reside in the claims hereinafter appended or any subsequently-filed claims, and their equivalents.

What is claimed is:

1. A computer-implemented method for identifying normalization violations, comprising:
receiving selection of one of a data model, a portion of the data model, and an object in the data model;
receiving selection of one or more normalization rules;
identifying one or more normalization violations in the one of the data model, the portion of the data model, and the object in the data model using the one or more normalization rules; and
displaying the one or more normalization violations.

2. The method of claim 1, wherein receiving selection of the one or more normalization rules further comprises receiving selection of one or more first normal form rules from a group consisting of: a primary key rule, a duplicate columns rule, a generated columns rule, and a repeating groups rule and wherein identifying the one or more normalization violations in the data model further comprises identifying one or more first normal form violations from the group.

3. The method of claim 1, wherein receiving selection of the one or more normalization rules further comprises receiving selection of a second normal form rule and wherein identifying the one or more normalization violations in the data model further comprises identifying one or more second normal form violations.

4. The method of claim 1, wherein receiving selection of the one or more normalization rules further comprises receiving selection of a third normal form rule and wherein identifying the one or more normalization violations in the data model further comprises identifying one or more third normal form violations

5. The method of claim 1, wherein the data model is selected from the group consisting of:
a physical data model and a logical data model.

6. The method of claim 1, further comprising:
receiving information about a dependency relationship to document denormalization of a denormalized table in the data model;
using the dependency relationship to modify the data model; and
providing a visual display of the dependency relationship in the data model.

7. The method of claim 1, further comprising:
discovering one or more dependencies in the one of the data model, the portion of the data model, and the object in the data model; and
displaying the one of the data model, the portion of the data model, and the object in the data model with the one or more dependencies identified.

8. A computer program product comprising a computer useable medium including a computer readable program, wherein the computer readable program when executed on a computer causes the computer to:
receive selection of one of a data model, a portion of the data model, and an object in the data model;
receive selection of one or more normalization rules;
identify one or more normalization violations in the one of the data model, the portion of the data model, and the object in the data model using the one or more normalization rules; and
display the one or more normalization violations.

9. The computer program product of claim 8, wherein, when receiving selection of the one or more normalization rules, the computer readable program when executed on a computer causes the computer to receive selection of one or more first normal form rules from a group consisting of: a primary key rule, a duplicate columns rule, a generated columns rule, and a repeating groups rule, and wherein, when identifying the one or more normalization violations in the data model, the computer readable program when executed on a computer causes the computer to identify one or more first normal form violations from the group.

10. The computer program product of claim 8, wherein, when receiving selection of the one or more normalization rules, the computer readable program when executed on a computer causes the computer to receive selection of a second normal form rule, and wherein, when identifying the one or more normalization violations in the data model, the computer readable program when executed on a computer causes the computer to identify one or more second normal form violations.

11. The computer program product of claim 8, wherein, when receiving selection of the one or more normalization rules, the computer readable program when executed on a computer causes the computer to receive selection of a third normal form rule, and wherein, when identifying the one or more normalization violations in the data model, the computer readable program when executed on a computer causes the computer to identify one or more third normal form violations.

12. The computer program product of claim 8, wherein the data model is selected from the group consisting of:
a physical data model and a logical data model.

13. The computer program product of claim 8, wherein the computer readable program when executed on a computer causes the computer to:
receive information about a dependency relationship to document denormalization of a denormalized table in the data model;
use the dependency relationship to modify the data model; and
provide a visual display of the dependency relationship in the data model.

14. The computer program product of claim 8, wherein the computer readable program when executed on a computer causes the computer to:
discover one or more dependencies in the one of the data model, the portion of the data model, and the object in the data model; and
display the one of the data model, the portion of the data model, and the object in the data model with the one or more dependencies identified.

15. A system, comprising:
logic capable of performing operations, the operations comprising:
receiving selection of one of a data model, a portion of the data model, and an object in the data model;
receiving selection of one or more normalization rules;
identifying one or more normalization violations in the one of the data model, the portion of the data model, and the object in the data model using the one or more normalization rules; and
displaying the one or more normalization violations.

16. The system of claim 15, wherein operations for receiving selection of the one or more normalization rules further comprise receiving selection of one or more first normal form rules from a group consisting of: a primary key rule, a duplicate columns rule, a generated columns rule, and a repeating groups rule and wherein operations for identifying the one or more normalization violations in the data model further comprise identifying one or more first normal form violations from the group.

17. The system of claim 15, wherein operations for receiving selection of the one or more normalization rules further comprise receiving selection of a second normal form rule and wherein operations for identifying the one or more normalization violations in the data model further comprise identifying one or more second normal form violations.

18. The system of claim 15, wherein operations for receiving selection of the one or more normalization rules further comprise receiving selection of a third normal form rule and wherein operations for identifying the one or more normalization violations in the data model further comprise identifying one or more third normal form violations

19. The system of claim 15, wherein the data model is selected from the group consisting of:
a physical data model and a logical data model.

20. The system of claim 15, wherein the operations further comprise:
receiving information about a dependency relationship to document denormalization of a denormalized table in the data model;
using the dependency relationship to modify the data model; and
providing a visual display of the dependency relationship in the data model.

21. The system of claim 15, wherein the operations further comprise:
discovering one or more dependencies in the one of the data model, the portion of the data model, and the object in the data model; and
displaying the one of the data model, the portion of the data model, and the object in the data model with the one or more dependencies identified.
